(19) United States
(12) Patent Application Publication
(10) Pub. No.: US 2010/0079860 A1
(43) Pub. Date: Apr. 1, 2010

(54) SCREEN

(75) Inventors: Teruhiko Unno, Shiojiri-shi (JP); Fumio Yuzawa, Matsumoto-shi (JP); Masato Maruyama, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/562,221

(22) Filed: Sep. 18, 2009

(30) Foreign Application Priority Data
Sep. 30, 2008 (JP) 2008-253784

(51) Int. Cl. G03B 21/58

(52) U.S. Cl. 359/443

(57) ABSTRACT

A screen includes: a rectangular flexible screen cloth having which image light is projected; tubular portions provided along respective side edges of the screen cloth; an annular member inserted into the tubular portions; a frame member having a plurality of arm members connected so as to be capable of bending and stretching and assuming a rectangular frame shape in a state in which the plurality of arm members are extended; four hooking portions provided at four corners of the frame member and configured to hook the annular member to position the screen cloth in the frame of the frame member; and a tension applying mechanism provided on the frame member and configured to apply a tensile force to the screen cloth, at least two of the four hooking portions are provided movably inside and outside the frame member, the tension applying mechanism urges the at least two hooking portions outward the frame.

The entire disclosure of Japanese Patent Application No. 2008-253784, filed Sep. 30, 2008, is expressly incorporated by reference herein.

### BACKGROUND

1. Technical Field

The present invention relates to a screen.

2. Related Art

In the related art, a folding-type screen improved in portability in the state of no-use is proposed as a screen on which image light emitted from a projector or the like in an enlarged scale is projected (for example, see International Publication WO02/097530).

The folding-type screen disclosed in International Publication WO02/097530 employs a rectangular frame-type supporting frame configured to be foldable by hinges as a member for supporting a screen cloth.

Then, the screen cloth is supported by the supporting frame by letting a plurality of cords through a plurality of holes formed on outer edge portions of the screen cloth and tying the plurality of cords to the supporting frame.

However, with the screen disclosed in International Publication WO02/097530, since the screen cloth is tied to the supporting frame by the plurality of cords using the plurality of holes formed on the screen cloth, the screen cloth is subject to crinkle when in use, so that there is a problem of lowering of the flatness of the screen cloth (projecting surface).

### SUMMARY

An advantage of some aspects of the invention is to provide a screen the flatness of a projecting surface of which is satisfactorily maintained when in use and the portability of which in the state of no-use is improved.

According to an aspect of the invention, there is provided a screen including: a rectangular flexible screen cloth on which image light is projected; tubular portions provided along respective side edges of the screen cloth; an annular member inserted into the tubular portions; a frame member having a plurality of arm members connected so as to be capable of bending and stretching and assuming a rectangular frame shape in a state in which the plurality of arm members are extended; four hooking portions provided at four corners of the frame member and configured to hook the annular member to position the screen cloth in the frame of the frame member; and a tension applying mechanism provided on the frame member and configured to apply a tensile force to the screen cloth, in which at least two of the four hooking portions are provided movably inside and outside the frame member, the tension applying mechanism urges the at least two hooking portions outward the frame.

According to the aspect of the invention, the screen cloth is positioned within the frame of the frame member by the annular member inserted into the tubular portions provided along the respective side edges of the screen cloth hooked by the four hooking portions provided on the frame member. Here, since the at least two hooking portions are urged outward the frame by the tension applying mechanism, the annular member is also urged outward the frame, and the tensile force is added outward the frame to the screen cloth via the annular member and the tubular portions.

Accordingly, in the state in which the plurality of arm members which constitute the frame member are extended and the projecting surface of the screen cloth is formed (extended state), the substantially entire portion of the outer edge of the screen cloth may be pulled outward the frame, and hence the flatness of the projecting surface is satisfactorily maintained without forming the crimple on the screen cloth.

Since the frame member is configured in such a manner that the plurality of arm members are connected so as to be capable of bending and stretching, downsizing is achieved by folding the frame member by bending the plurality of arm members when the screen is in the state of no-use, and hence the portability is improved.

By setting the bending direction of the adjacent arm members (the position to dispose a hinge or the like which connects the respective arm members) as needed, the frame member may be folded in a state in which the screen cloth is installed on the frame member, so that the improvement of the convenience is achieved.

Preferably, the annular member includes: a cord-type annular member body; and an urging member connecting both ends of the annular member body.

When the annular member is formed only of the cord-shaped annular member body having a relatively high rigidity, the following inconveniences may be resulted.

In other words, the annular member is formed by tying the both ends of the cord-type annular member body with respect to each other. Therefore, when forming a plurality of annular members for manufacturing the plurality of screens, even though the respective annular member bodies are set to a predetermined length, a peripheral length of the respective annular members may vary depending on how it is tied up (the length of a tied portion). Since the screen cloth is installed on the frame member by hooking the annular member on the four hooking portions, if the peripheral lengths of the annular members vary, the state of installation of the screen cloth (the state of flatness of the projecting surface) varies on the screen-to-screen basis.

Also, when urging the annular member outward the frame via the hooking portions by the tension applying mechanism, if the rigidity of the annular member (the annular member body) is high, only portions of the annular member near the hooking portions are apt to be urged outward the frame, and it is difficult to apply the tensile force outward the frame on the entire screen cloth.

According to the aspect of the invention, the annular member includes the annular member body, and the urging member for connecting the both ends of the annular member body, and hence is configured to be elastic.

Accordingly, the urging member functions as a buffer of the tied portions and hence even though the plurality of annular members are formed for manufacturing the plurality of screens, variations in peripheral length of the annular members may be restrained. Therefore, the state of installation of the screen cloth may be substantially equalized in the manufactured individual screens.

Also, since the annular member is elongated when the annular member is urged outward the frame by the tension applying mechanism via the hooking portion, the tensile force may be applied outward the frame to the entire portion of the screen cloth via the tubular portions, so that the flatness of the projecting surface may further be improved to a preferable state.

According to another aspect of the invention there is provided a screen including: a foldable screen cloth; a frame member configuring an outer frame of the screen cloth and having a foldable hinge structure; bag-shaped portions configured at four side ends of the screen cloth; and a cord inserted in the bag-shaped portions, in which the bag-shaped portions expose the cord at predetermined positions at four corners of the screen cloth, and the screen cloth is uniformly extended by applying a tensile force to the exposed cord at the predetermined positions when the frame member and the screen cloth are extended.

### BRIEF DESCRIPTION OF THE DRAWINGS

The invention will be described with reference to the accompanying drawings, wherein like numbers reference like elements.

FIG. 1 is a drawing showing a schematic configuration of a screen according to an embodiment.

FIG. 2 is a drawing showing a schematic configuration of the screen according to the embodiment.

FIG. 3 is a drawing showing a configuration of a screen cloth according to the embodiment.

FIG. 4 is a drawing showing a configuration of a tubular portion according to the embodiment.

FIG. 5 is a drawing showing a configuration of an annular member according to the embodiment.

FIG. 6 is a perspective view showing a configuration of a frame member according to the embodiment.

FIG. 7 is a perspective view showing a configuration of a frame member according to the embodiment.

FIG. 8 is a schematic view for explaining configurations of a hooking portion and a tension applying mechanism according to the embodiment.

FIG. 9 is a schematic view for explaining a structure in which a tensile force is applied to the screen cloth by the hooking portion and the tension applying mechanism according to the embodiment.

FIG. 10 is one of explanatory drawings for explaining a series of actions to set the screen in the embodiment from the extended state to the stored state.

FIG. 11 is one of explanatory drawings for explaining a series of actions to set the screen in the embodiment from an extended state to a stored state.

FIG. 12 is one of explanatory drawings for explaining a series of actions to set the screen in the embodiment from the extended state to the stored state.

FIG. 13 is one of explanatory drawings for explaining a series of actions to set the screen in the embodiment from the extended state to the stored state.

### DESCRIPTION OF EXEMPLARY EMBODIMENTS

Referring now to the drawings, an embodiment of the invention will be described.

### Rough Configuration of Screen

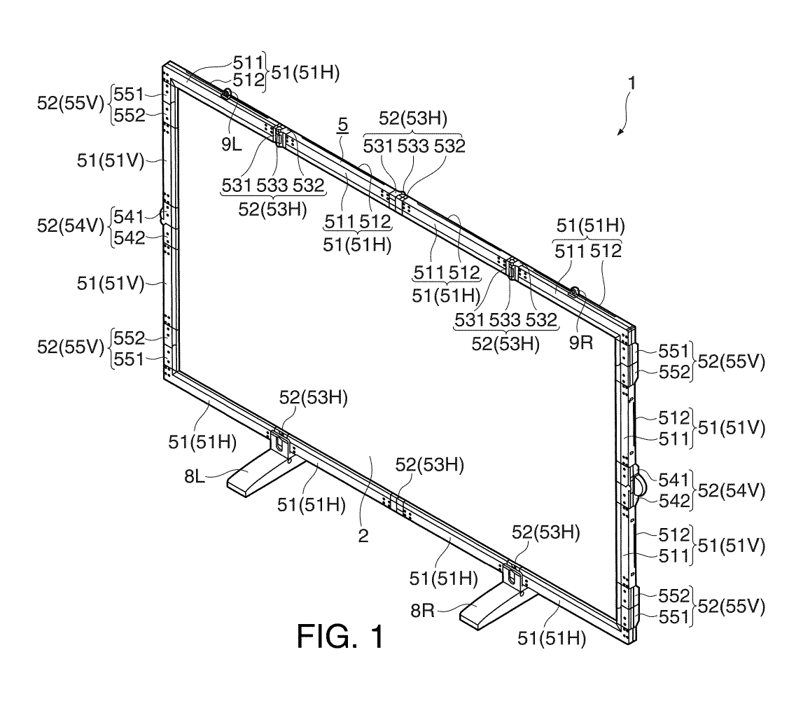

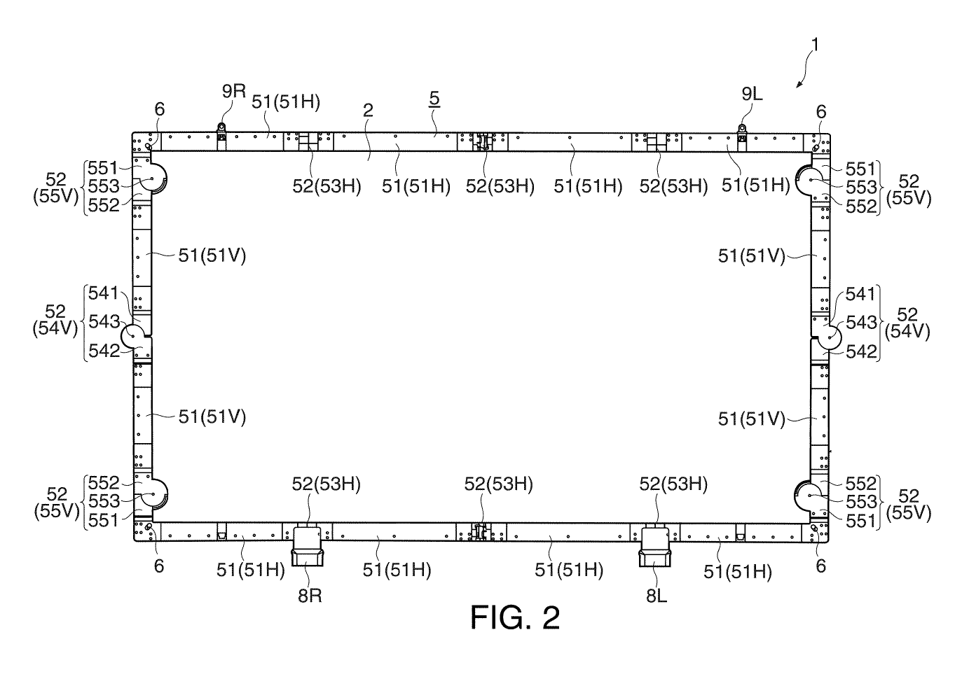

FIG. 1 and FIG. 2 are drawings showing schematic configurations of a screen 1. More specifically, FIG. 1 is a perspective view of the screen 1 in a state in which a projecting surface is formed when viewed from a front side. FIG. 2 is a perspective view of the screen 1 in the same state as in FIG. 1 when viewed from a back side.

In the following description, in the state in which the projecting surface of a screen cloth 2 is formed, the side of the projecting surface is referred to as a front surface, the opposite side from the projecting surface is referred to as a back surface, the right and left thereof when viewed from the front side are referred to as “right” and “left” for the sake of convenience.

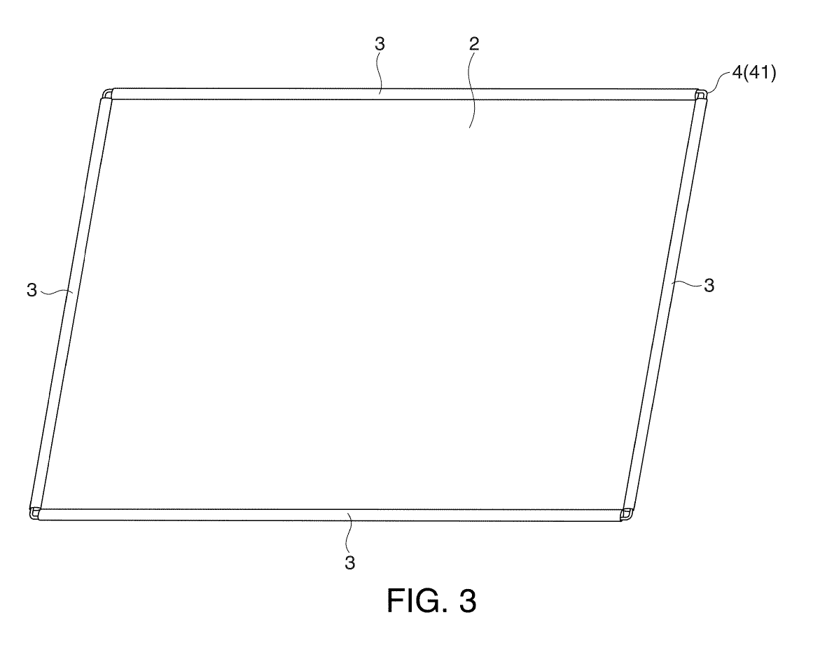

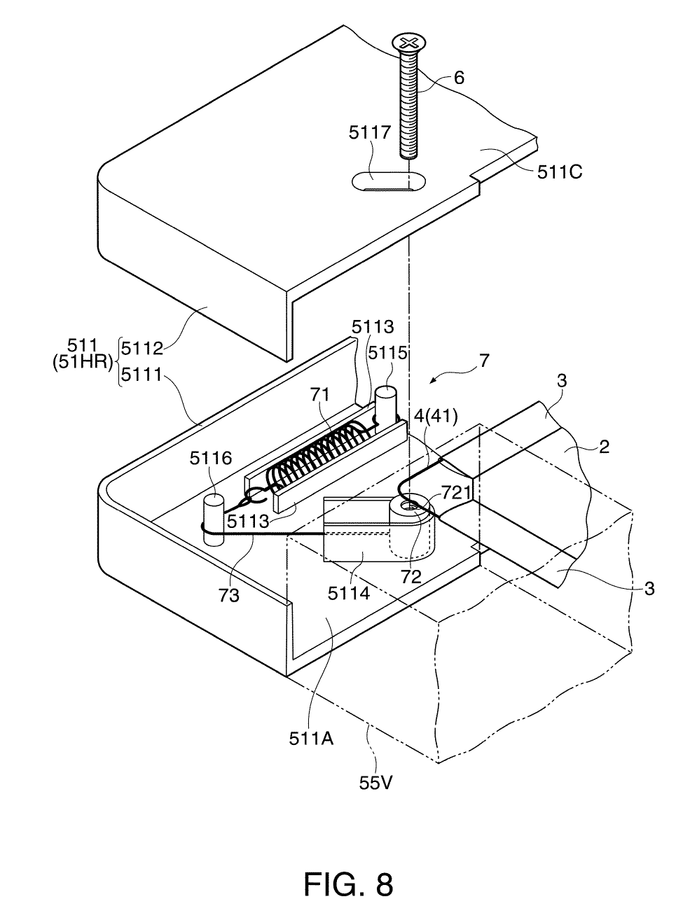

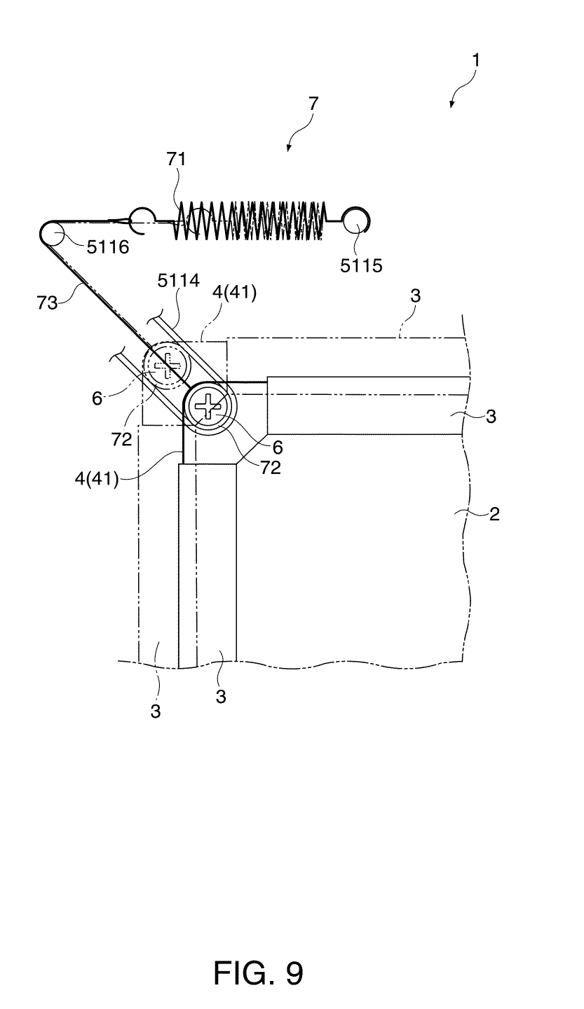

On the screen 1, image light emitted, for example, from a projector or the like in an enlarged scale is projected. The screen 1 includes the screen cloth 2, four tubular portions 3 (see FIG. 3), an annular member 4 (see FIG. 3), a frame member 5, four hooking portions 6 (see FIG. 2 and FIG. 9), and four tension applying mechanisms 7 (see FIG. 8) as shown in FIG. 1 or FIG. 2.

Configuration of Screen Cloth

FIG. 3 is a drawing showing a configuration of the screen cloth 2.

The screen cloth 2 is formed into a flexible sheet form, and incoming image light is projected thereon. In this embodiment, the screen cloth 2 is formed of a reflective screen which reflects the incoming image light.

### Configuration of Tubular Portion

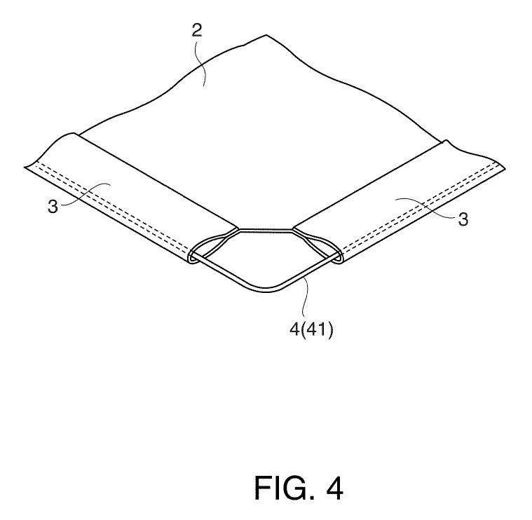

FIG. 4 is a drawing showing a configuration of the tubular portion 3. More specifically, FIG. 4 is an enlarged perspective view of a corner portion of the screen cloth 2.

The four tubular portions 3 are provided respectively along upper, lower, left, and right side edges of the screen cloth 2 as shown in FIG. 3.

In this embodiment, excessive areas are provided respectively at the upper, lower, left, and right portions of the rectangular projecting surface as the screen cloth 2. Then, by folding and stitching the respective portions, the tubular portions 3 are provided respectively along the upper, lower, left, and right side edges of the screen cloth 2. In other words, the tubular portions 3 are formed of the same cloth as the screen cloth 2.

### Configuration of Annular Member

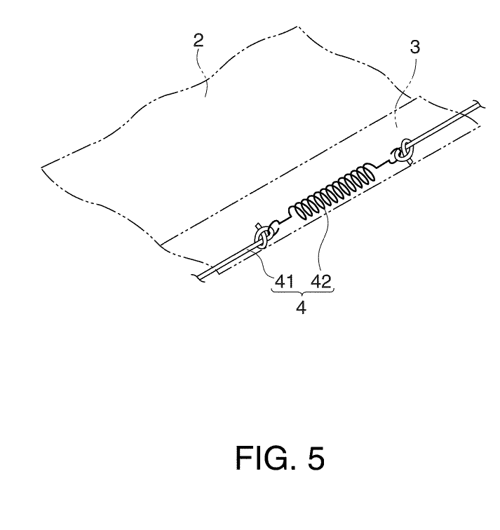

FIG. 5 is a drawing showing a configuration of the annular member 4. More specifically, FIG. 5 is a drawing showing part of the side edge of the screen cloth 2.

The annular member 4 is a cord-type annular member body 41, both ends of which are connected to form an annular shape, and is inserted respectively into the four tubular portions 3 as shown in FIG. 3.

The annular member 4 includes the annular member body 41 and a tension spring 42 as an urging member (FIG. 5) as shown in FIG. 3 to FIG. 5.

In this embodiment, the annular member body 41 is formed of a nylon string. The annular member body 41 is not limited to the nylon string, and cord-like members of other types may be employed.

The tension spring 42 is a member configured to connect the both ends of the annular member body 41 as shown in FIG. 5. In other words, by connecting the both ends of the annular member body 41 formed of a single cord with the tension spring 42 for example, the annular member 4 is configured to be elastic by the urging force of the tension spring 42.

The position to dispose the tension spring 42 of the annular member 4 is any one of the interiors of the four tubular portions 3 as shown in FIG. 5.

### Configuration of Frame Member

As show in FIG. 1 or FIG. 2, the frame member 5 has a rectangular frame shape, and is configured to allow installation of the screen cloth 2 thereon with the four tubular portions 3, the annular member 4, and the four hooking portions 6. Also as shown in FIG. 1 or 2, the frame member 5 includes twelve arm members 51, twelve hinge units 52 configured to connect the twelve arm members 51 so as to be capable of bending and stretching.

In the following description, the four each of arm members 51 which are disposed on the upper side and the lower side and are connected so as to extend horizontally from the twelve arm members 51 have the substantially same configuration, and hence are referred to as “horizontal arm members 51H”.

Also, the two each of arm members 51 which are disposed on the left side and the right side and are connected so as to extend vertically have the substantially same configuration, and hence are referred to as “vertical arm members 51V”.

The three each of hinge units 52 which are configured to connect four each of the horizontal arm members 51H on the upper side and the lower side from the twelve hinge units 52 have the substantially same configuration, and hence are referred to as “horizontal hinge units 53H”.

Also, the one each of hinge unit 52 which are configured to connect the two each of vertical arm members 51V on the left and right side from the twelve hinge units 52 have the substantially same configuration, and hence are referred to as “first vertical hinge units 54V”.

The four hinge units 52 which are disposed at four corners of the frame member 5 for connecting the horizontal arm members 51H and the vertical arm members 51V from the twelve hinge units 52 have the substantially same configuration, and hence are referred to as “second vertical hinge units 55V”.

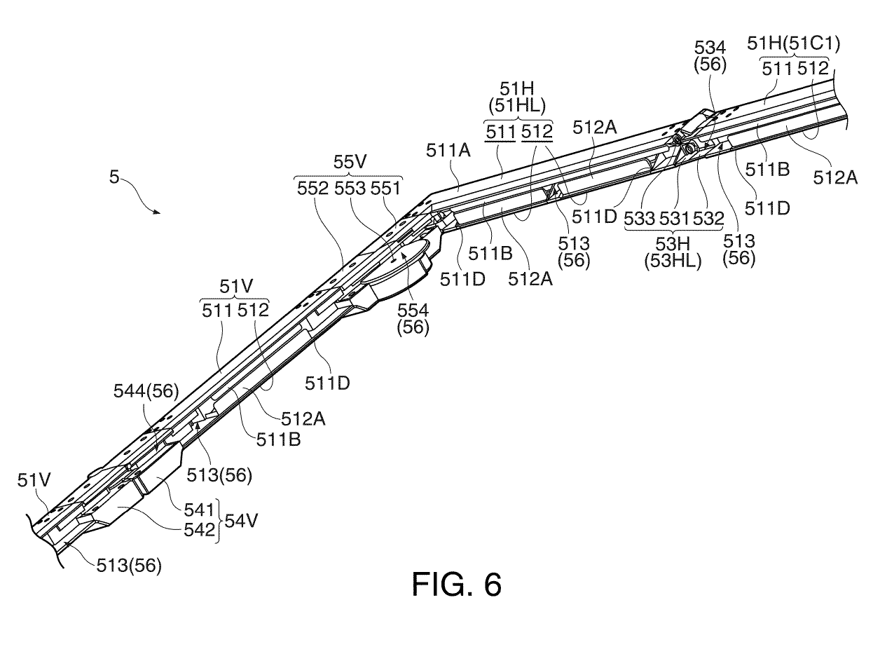

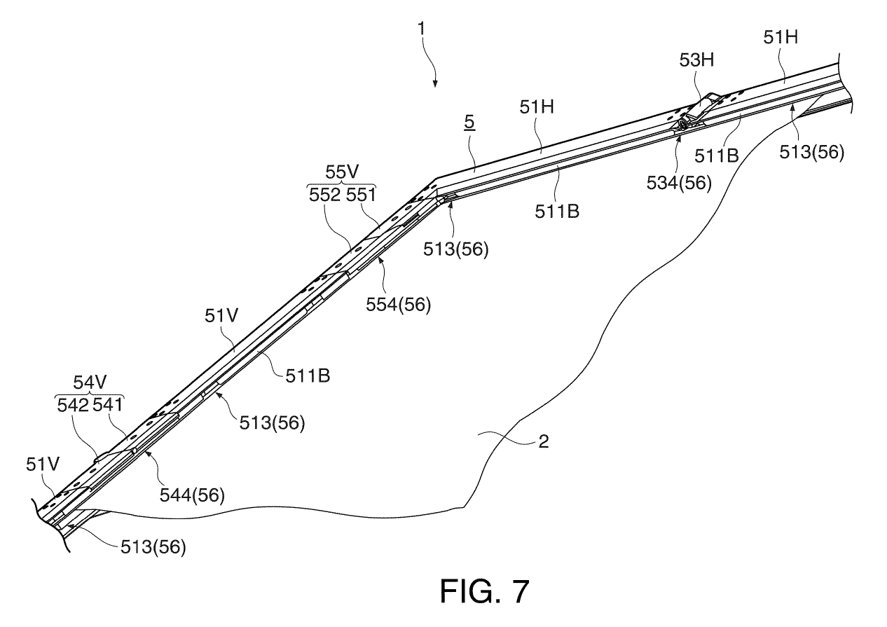

FIG. 6 and FIG. 7 are perspective views showing the configuration of the frame member 5. More specifically, FIG. 6 is a perspective view of the upper left side of the frame member 5 viewed from the front side. FIG. 7 is a drawing showing a state in which the screen cloth 2 is installed on the frame member 5 shown in FIG. 6.

Since the respective arm members 51 have the substantially same configuration, the horizontal arm member 51H positioned on the upper left side will be described as a representative in the following description.

The horizontal arm portion 51H roughly includes an arm member body 511 and clamping members 512 and generally has a substantially column shape as shown in FIG. 6.

The arm member body 511 has a substantially U-shape in cross section, and is disposed in such a manner that an opened portion of the U-shape is positioned inside the frame member 5. In other words, the arm member body 511 is formed with a first depressed portion 513 which extends along the direction of extension of the horizontal arm member 51H inside the frame member 5.

The arm member body 511 includes a first projecting portion 511B projecting toward the back side and extending along the direction of extension of the horizontal arm member 51H formed on a distal end portion (the portion inside the frame member 5) of an end surface portion 511A on the front side of the frame member 5 as shown in FIG. 6.

The arm member body 511 also includes a notched portion 511D of a U-shape in plan view formed at an (back side) end surface portion 511C of the frame member 5 from the distal end portion to a proximal end portion (outward from inside the frame member 5).

The clamping member 512 has a panel shape and is configured to be detachably attached to the back side of the arm member body 511, and is configured to close the notched portion 511D of the arm member body 511 by being attached to the arm member body 511 to form the end surface on the back side of the frame member 5.

The clamping member 512 includes a second projecting portion 512A projecting toward the front side and extending along the direction of extension of the horizontal arm member 51H formed at a position facing the first projecting portion 511B when being attached to the arm member body 511 as shown in FIG. 6.

The horizontal hinge unit 53H has a configuration in which a first connecting portion 531 which is connected to one of the adjacent horizontal arm members 51H and a second connecting portion 532 connected to the other horizontal arm member 51H are connected to each other so as to be rotatable about a first revolving shaft 533 extending in the vertical direction.

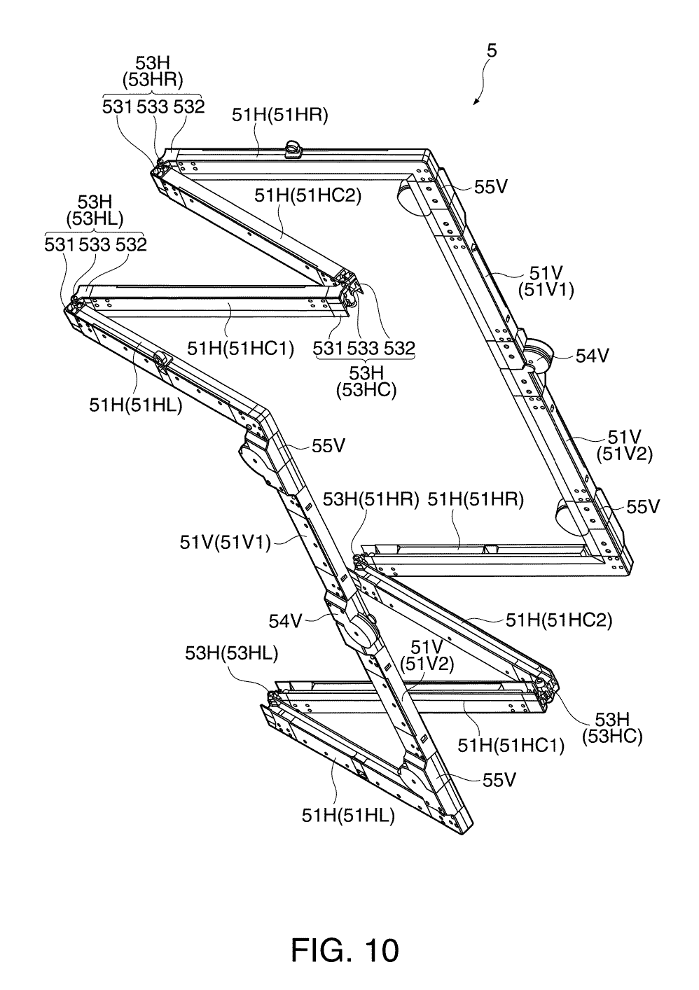

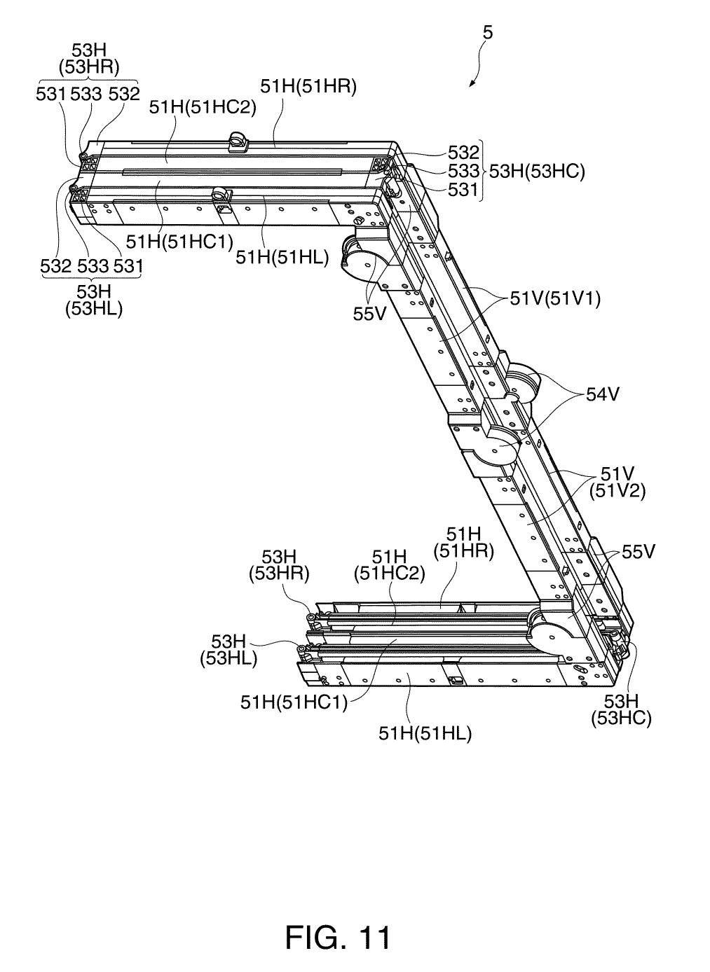

More specifically, the horizontal hinge unit 53H is connected in such a manner that the respective connecting portions 531 and 532 are rotatable by 180° about the first revolving shaft 533. In other words, by the rotation of the respective connecting portions 531 and 532 about the first revolving shaft 533, the two horizontal arm members 51H connected by the horizontal hinge unit 53H are moved to an extended state (see FIGS. 1, 2, and 6), which is a linear state in the horizontal direction, and a bent state (see FIGS. 10 and 11), which is a state of being overlapped with each other, respectively.

A horizontal hinge unit 53HC positioned at a center from the three horizontal hinge units 53H disposed on the upper side is disposed in such a manner that the connected two horizontal arm members 51H (51HC1 and 51HC2) are bent toward the back side (see FIGS. 10 and 11).

The other two horizontal hinge units 53HL and 53HR are disposed in such a manner that the connected two horizontal arm members 51H (51HL and 51HC1, 51HC2 and 51HR) are bent toward the front side (see FIGS. 10 and 11).

The three horizontal hinge units 53H disposed on the lower side are also disposed in the same manner as the above-described horizontal hinge units 53HC, 53HL, and 53HR (see FIGS. 10 and 11).

The horizontal hinge unit 53HL is positioned in such a manner that the first revolving shaft 533 is positioned on the front side with respect to the respective connecting portions 531 and 532 in a state in which the connected two horizontal arm members 51HL and 51C1 are extended in a linear state as shown in FIG. 6. In the above-described state, a second depressed portion 534 which extends along the direction of extension of the horizontal arm member 51H and communicates with the first depressed portion 513 provided in the horizontal arm member 51H is formed at the respective connecting portions 531 and 532 on the end surface inside the frame member 5.

Although not shown in the drawing in detail, since the horizontal hinge unit 53HR is disposed in the same manner as the horizontal hinge unit 53HL, it has the same second depressed portion 534. Although not shown in the drawing in detail, since the horizontal hinge unit 53HC is disposed in the state in which the horizontal hinge unit 53HL is rotated about a vertical shaft by 180°, it has the same second depressed portion 534 as the horizontal hinge unit 53HL.

As shown in FIG. 6, the first vertical hinge unit 54V has a configuration in which a first connecting portion 541 which is connected to one of the adjacent vertical arm members 51V and a second connecting portion 542 connected to the other vertical arm member 51V are connected to each other so as to be rotatable about a second revolving shaft 543 (FIG. 2) extending along the fore-and-aft direction (direction orthogonal to the paper plane of FIG. 2).

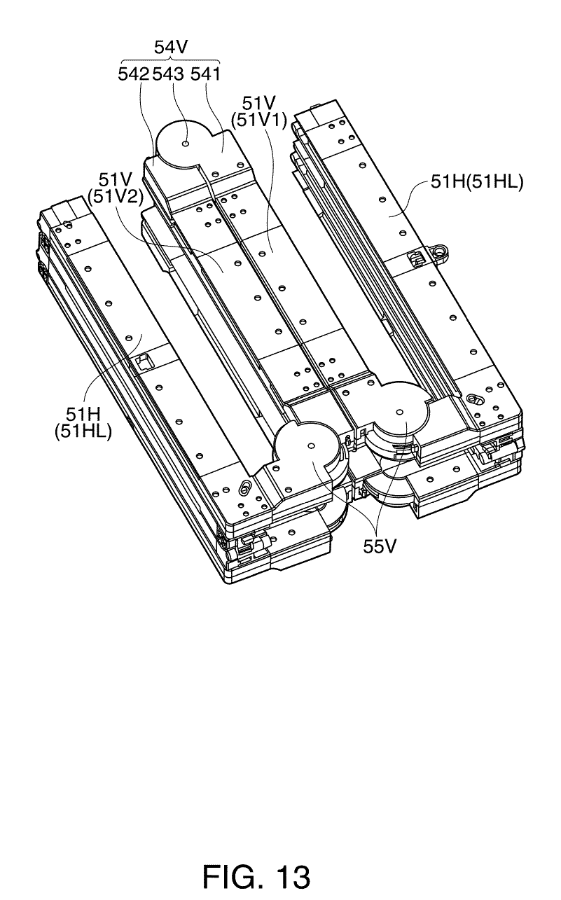

More specifically, the first vertical hinge unit 54V is disposed in such a manner that the respective connecting portions 541 and 542 are connected so as to be rotatable about the second revolving shaft 543 by 180° and the connected two vertical arm members 51V (51V1 and 51V2) are bent outward the frame member 5 (see FIG. 13).

Then, by the rotation of the respective connecting portions 541 and 542 about the second revolving shaft 543, the respective vertical arm members 51V are moved to the extended state (see FIGS. 1, 2, and 6), which is the linear state in the vertical direction, and the bent state (see FIG. 13), which is a state of being overlapped with each other, respectively.

The first vertical hinge unit 54V is positioned in such a manner that the second revolving shaft 543 is positioned outside the frame member 5 with respect to the respective connecting portions 541 and 542 in a state in which the connected two vertical arm members 51V are extended in the linear state as shown in FIG. 2. In the above-described state, as shown in FIG. 6, a third depressed portion 544 which extends along the direction of extension of the vertical arm members 51V and communicates with the first depressed portion 513 provided in the vertical arm member 51V is formed at the respective connecting portions 541 and 542 on the end surface inside the frame member 5.

As shown in FIG. 6, the second vertical hinge unit 55V has a configuration in which a third connecting portion 551 connected to the horizontal arm member 51H positioned at the corner portion of the frame member 5 and a fourth connecting portion 552 connected to the vertical arm member 51V are connected to each other so as to be rotatable about a third revolving shaft 553 (FIG. 2) extending along the fore-and-aft direction.

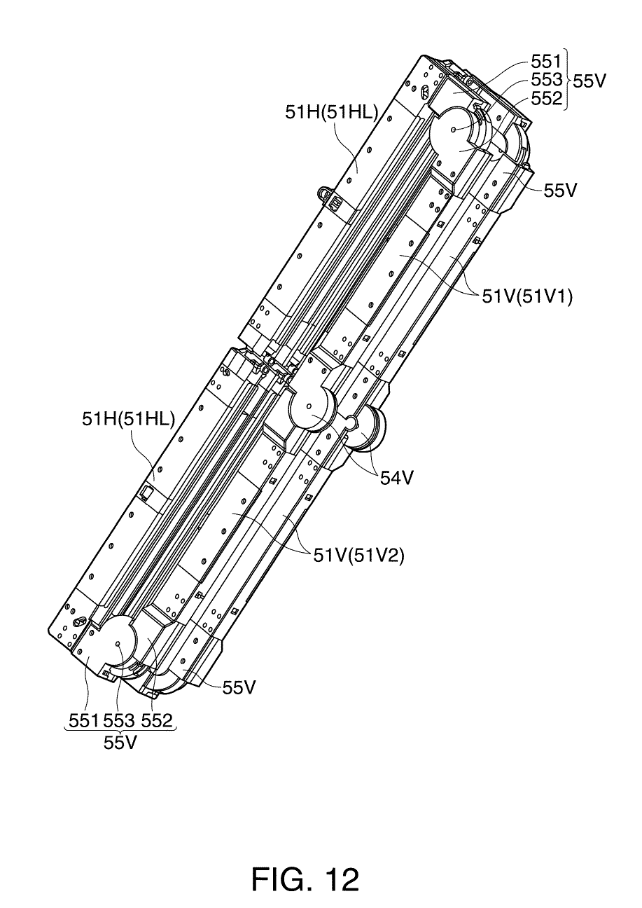

More specifically, the second vertical hinge unit 55V is disposed in such a manner that the respective connecting portions 551 and 552 are connected so as to be rotatable about the third revolving shaft 553 by 90° and the connected respective arm members 51H and 51V are bent inward the frame member 5 (see FIG. 12).

Then, by the rotation of the respective connecting portions 551 and 552 about the third revolving shaft 553, the respective arm members 51H and 51V are moved to the extended state (see FIGS. 1, 2, and 6) so as to be orthogonal to each other, and the bent state (see FIG. 12), which is a state of being overlapped with each other, respectively.

The second vertical hinge unit 55V is positioned in such a manner that the third revolving shaft 553 is positioned inside the frame member 5 with respect to the respective connecting portions 551 and 552 in a state in which the connected respective arm members 51H and 51V are extended so as to be orthogonal to each other as shown in FIG. 6. In the above-described state, a fourth depressed portion 554 which extends along the direction of extension of the vertical arm member 51V and communicates with respective first depressed portions 513 provided in the respective arm members 51H and 51V is formed at the respective connecting portions 551 and 552 on the end surface inside the frame member 5.

In this configuration, by the communication of the first to the fourth depressed portions 513, 534, 544, and 554, a storage portion 56 configured to store the four tubular portions 3 provided on the upper, lower, left, and right side edges of the screen cloth 2 is formed inside the frame member 5. In other words, in a state where the screen 1 is assembled, the four tubular portions 3 are stored in the storage portion 56, and are invisible from the outside (FIG. 1).

Here, when storing the four tubular portions 3 in the storage portion 56, the four tubular portions 3 are stored in the storage portion 56 in a state in which the clamping member 512 is removed from the arm member body 511, and then, the clamping member 512 is attached to the arm member body 511. With the storage in such a manner, a connecting portion between the screen cloth 2 and the tubular portion 3 is clamped between the respective projecting portions 511B and 512A so that the tubular portions 3 are prevented from being pulled inwardly the frame member 5 as shown in FIG. 7.

### Configuration of Hooking Portion and Tension Applying Mechanism

FIG. 8 is a schematic drawing for explaining the configurations of the hooking portion 6 and the tension applying mechanism 7. More specifically, FIG. 8 is an exploded perspective view of an upper right corner portion of the frame member 5 viewed from the back side.

Before describing the configurations of the hooking portion 6 and the tension applying mechanism 7, the configuration of the horizontal arm member 51H to be disposed at the corner of the frame member 5 will be described more in detail.

The four horizontal arm members 51H disposed at the corner portions of the frame member 5 have the same configuration, a horizontal arm member 51HR disposed at the upper right corner portion will be described as a representative in the following description. It is the same also for the hooking portion 6 and the tension applying mechanism 7.

The arm member body 511 which constitutes the horizontal arm member 51HR includes two halves on the front side and the back side, and includes a front side arm member 5111 and a back side arm member 5112 as shown in FIG. 8.

On an inner surface of the front side end surface portion 511A of the front side arm member 5111 at a position corresponding to the corner portion of the frame member 5, storage ribs 5113, a movement guiding rib 5114, a spring connecting projection 5115, and a hooking projection 5116 are formed so as to project backward.

The storage ribs 5113 are members to store a resilient member 71, described later, which constitutes the tension applying mechanism 7, extend in the horizontal direction and constitute a pair extending in the vertical direction so as to oppose to each other.

The movement guiding rib 5114 is a rib configured to store a moving member 72, described later, which constitutes the tension applying mechanism 7 and guide the movement of the moving member 72, and is formed into a U-shape in plan view having an opening portion of the U-shape directed outward along a diagonal line of the frame member 5 as shown in FIG. 8.

The spring connecting projection 5115 is a projection to which an end of the resilient member 71 is connected, has a column shape, and is formed between the pair of storage ribs 5113.

The hooking projection 5116 is a projection configured to hook a wire 73, described later, which constitutes the tension applying mechanism 7, and is formed on the diagonal line of the frame member 5 so as to face the opening portion of the U-shape of the movement guiding rib 5114.

On the back side end surface portion 511C of the back side arm member 5112 at a position corresponding to the movement guiding rib 5114, an elongated hole 5117 extending in the direction of the diagonal line of the frame member 5 is formed.

The hooking portions 6 are provided at the corner portions of the frame member 5 and are members for hooking the annular member 4 inserted into the four tubular portions 3 to restrain the annular member 4 to move inwardly the frame.

In this embodiment, the hooking portions 6 each employ so-called a screw as shown in FIG. 8.

The tension applying mechanism 7 is a mechanism configured to apply a tensile force to the screen cloth 2 by urging the hooking portion 6 outwardly the frame member 5. The tension applying mechanism 7 includes the resilient member 71, the moving member 72, and the wire 73 as shown in FIG. 8.

The resilient member 71 is a member configured to urge the moving member 72 along the movement guiding rib 5114 outward in the direction of the diagonal line of the frame member 5.

In this embodiment, the resilient member 71 is formed of so-called a tension spring as shown in FIG. 8. Then, the resilient member 71 is connected at one end to the spring connecting projection 5115, and at the other end to the wire 73.

The moving member 72 has a substantially cylindrical shape and is arranged in the interior of the movement guiding rib 5114 in a loosely fitted state. Then, the moving member 72 is formed with a screw hole 721 which allows the hooking portion 6 to be screwed in as shown in FIG. 8.

The wire 73 is extended between the resilient member 71 and the moving member 72 in a state of being hooked on the hooking projection 5116 as shown in FIG. 8.

FIG. 9 is a schematic drawing for explaining a structure in which the tensile force is applied to the screen cloth 2 by the hooking portion 6 and the tension applying mechanism 7.

First of all, the four tubular portions 3 provided along the upper, lower, left, and right side edges of the screen cloth 2 are stored in the storage portion 56.

In this state, the each corner portion of the annular member 4 is positioned in the interior of a connecting portion between the horizontal arm member 51H and the second vertical hinge unit 55V (at an intersection between the first depressed portion 513 and the fourth depressed portion 554).

In the state described above, although not shown in detail, the each corner portion of the annular member 4 and the moving member 72 are visible from the outside via the elongated hole 5117.

Then, in the state described above, the hooking portion 6 is inserted into the interior of the horizontal arm member 51H via the elongated hole 5117, and is screwed into the screw hole 721 of the moving member 72 while hooking the corner portion of the annular member 4.

In this state, since the moving member 72 is urged outward in the direction of the diagonal line of the frame member 5 by the resilient member 71 via the wire 73, the hooking portion 6 screwed into the moving member 72 is also urged outward in the direction of the diagonal line.

Therefore, as indicated by a double-dashed chain line in FIG. 9, the corner portion of the annular member 4 hooked on the hooking portion 6 is also urged outward in the direction of the diagonal line in association with the urging of the hooking portion 6 outward in the direction of the diagonal line, so that the tensile force is applied to the screen cloth 2 via the annular member 4 and the tubular portion 3.

### Storage Structure of Screen

FIGS. 10 to 13 are explanatory drawings for explaining a series of actions to set the screen 1 in the embodiment from the extended state to the stored state in sequence. More specifically, FIGS. 10 to 13 are perspective views of the screen 1 viewed from the front left side.

In FIGS. 10 to 13, the screen cloth 2 is not shown for the sake of convenience of explanation.

In order to set the screen 1 from the state in which the respective arm members 51 are extended by the respective hinge units 52 and the projecting surface of the screen cloth 2 is formed (extended state (FIG. 1)) to a state in which the screen 1 is portable by bending the respective arm members 51 by the respective hinge units 52, the respective arm members 51 are bent as described below.

First of all, as shown in FIG. 10, the respective horizontal arm members 51HC1 and 51HC2 are bent backward by the respective horizontal hinge units 53HC, 53HL, and 53HR disposed on the upper and lower side, and the respective horizontal arm members 51HL and 51HR are bent forward with respect to the respective horizontal arm members 51HC1 and 51HC2. Then, as shown in FIG. 11, the respective horizontal arm members 51HL, 51HC1, 51HC2, and 51HR disposed on the upper and lower sides are set into an overlapped state.

Subsequently, as shown in FIG. 12, the respective horizontal arm members 51HL and 51HR on the upper side are bent toward the respective vertical arm members 51V1 on the left and right by the four second vertical hinge portions 55V, and the respective horizontal arm members 51HL and 51HR on the lower side toward the respective vertical arm members 51V2 on the left and right.

Finally, as shown in FIG. 13, the respective vertical arm members 51V1 and 51V2 on the left and right are bent by the first vertical hinge units 54V on the left and right to set the respective vertical arm members 51V1 and 51V2 into an overlapped state.

By the operation as described above, the frame member 5 is set to a stored state having a substantially W-shape in plan view as shown in FIG. 13.

The screen 1 is set from the stored state to the extended state by flowing the steps as described above in a reverse order.

Then, for example, by mounting supporting legs 8L and 8R at positions of the respective horizontal hinge units 53HL and 53HR on the lower side of the frame member 5 after having set the screen 1 to the extended state as shown in FIGS. 1 and 2, setting of the screen 1 in the state of standing on a floor is achieved.

In addition to the setting on the floor, the screen 1 may be set in a state of being hung from a ceiling by inserting wires or the like through hanging fixtures 9L and 9R (FIGS. 1 and 2) provided on an upper end surface of the upper horizontal arm member 51H of the frame member 5 and connecting the wire or the like to a ceiling surface.

According to the embodiment of the invention, the following effects are achieved.

In this embodiment, the screen 1 includes the four tubular portions 3, the annular member 4, the four hooking portions 6, and the four tension applying mechanisms 7 in addition to the screen cloth 2 and the frame member 5. In other words, in the extended state, since the hooking portion 6 is urged outward the frame by the tension applying mechanism 7, the annular member 4 is urged outward the frame, and the tensile force may be added outward the frame to the screen cloth 2 via the annular member 4 and the four tubular portions 3. Therefore, in the extended sate, the substantially entire portion of the outer edge of the screen cloth 2 may be pulled outward the frame, and hence the flatness of the projecting surface is maintained without forming the crimple on the screen cloth 2.

Since the frame member 5 is configured in such a manner that the twelve arm members 51 are connected by the twelve hinge units 52 so as to be capable of bending and stretching, downsizing is achieved by folding the frame member 5 by bending the twelve arm members 51 when the screen 1 is in the state of no-use, and hence the portability is improved.

In addition, since the horizontal hinge unit 53H, the first vertical hinge unit 54V, and the second vertical hinge unit 55V are disposed on the above-described positions as the twelve hinge units 52, folding of the frame member 5 is achieved in a state in which the screen cloth 2 is installed on the frame member 5, so that improvement of the convenience is achieved.

The annular member 4 includes the cord-type annular member body 41 and the tension spring 42 connecting both ends of the annular member body 41 and hence is configured to be elastic.

Accordingly, the tension spring 42 functions as a buffer of tied portions of both ends of the annular member body 41 in comparison with the case where the annular member 4 is configured only by the annular member body 41, and hence even though the plurality of annular members 4 are formed for manufacturing the plurality of screens 1, variations in peripheral length of the annular members 4 may be restrained. Therefore, the state of installation of the screen cloth 2 (the state of the flatness of the projecting surface) may be substantially equalized in the manufactured individual screens 1.

Also, since the annular member 4 is elongated when the annular member 4 is urged outward the frame by the tension applying mechanism 7 via the hooking portion 6, the tensile force may be applied outward the frame to the entire portion of the screen cloth 2 via the four tubular portions 3, so that the flatness of the projecting surface may further be improved to a preferable state.

The invention is not limited to the embodiments described above, and includes modifications and improvements within a scope which achieves the advantages of the invention.

In the embodiment described above, the configuration of the frame member 5 is not limited to the configuration described in this embodiment, that is, the number and the shape of the arm member 51, the number and the shape of the hinge unit 52, and the positions where these members are disposed are not limited to the configuration described in the embodiment, and other numbers, shapes, and positions of arrangement may be employed.

Although the four tension applying mechanisms 7 are provided in the embodiment described above, the invention is not limited thereto and, for example, a configuration in which only two tension applying mechanisms 7 are provided so as to urge the two hooking portions 6 positioned on the diagonal line of the frame member 5 may be employed as long as it is configured to urge at least the two hooking portions 6.

Although the tubular portions 3 are formed by stitching the screen cloth 2 in the embodiment described above, the invention is not limited thereto, and a configuration in which the tubular portions 3 are formed separately from the screen cloth 2 and are connected to the upper, lower, left, and right side edges of the screen cloth 2 is also applicable.

Although the clamping member 512 (second projecting portion 512A) is configured to be detachably attached with respect to the arm member body 511 in the embodiment described above, the invention is not limited thereto, and a configuration in which only the second projecting portion 512A is detachably attached to the arm member 51 is also applicable. It is also possible to configure the respective projecting portions 511B and 512A so as to be detachably attached to the arm member 51.

Although the screen cloth 2 is formed of the reflective-type screen in the embodiment described above, the invention is not limited thereto, and the screen cloth 2 may be formed of a transmissive screen which allows passage of incoming image light to display the projected image.

Since the screen according to the embodiment of the invention is able to maintain the flatness of the projecting surface satisfactorily, and the portability is improved in the state of no-use, it is usable as a screen on which the image light emitted from the projector or the like in an enlarged scale is projected.

What is claimed is:

1. A screen comprising:
a rectangular flexible screen cloth on which image light is projected;
tubular portions provided along respective side edges of the screen cloth;
an annular member inserted into the tubular portions;
a frame member having a plurality of arm members connected so as to be capable of bending and stretching and assuming a rectangular frame shape in a state in which the plurality of arm members are extended;
four hooking portions provided at four corners of the frame member and configured to hook the annular member to position the screen cloth in the frame of the frame member; and
a tension applying mechanism provided on the frame member and configured to apply a tensile force to the screen cloth,
at least two of the four hooking portions are provided movably inside and outside the frame member,
the tension applying mechanism urges the at least two hooking portions outward the frame.

2. The screen according to claim 1, wherein
the annular member includes:
a cord-type annular member body; and
an urging member connecting both ends of the annular member body.

3. A screen comprising:
a foldable screen cloth;
a frame member configuring an outer frame of the screen cloth and having a foldable hinge structure;
bag-shaped portions configured at four side ends of the screen cloth; and
a cord inserted in the bag-shaped portions,
the bag-shaped portions expose the cord at predetermined positions at four corners of the screen cloth, and
the screen cloth is uniformly extended by applying a tensile force to the exposed cord at the predetermined positions when the frame member and the screen cloth are extended.
